(19) United States
(12) Patent Application Publication
(10) Pub. No.: US 2024/0265107 A1
(43) Pub. Date: Aug. 8, 2024

(54) SYSTEMS AND METHODS FOR USING A MANAGEMENT CONTROLLER TO SECURELY MONITOR AND ENFORCE INTEGRITY OF BIOS MODULES DURING BOOT PROCESS OF INFORMATION HANDLING SYSTEM

(71) Applicant: Dell Products L.P., Round Rock, TX (US)

(72) Inventors: Balasingh P. SAMUEL, Round Rock, TX (US); Michael W. ARMS, Copperas Cove, TX (US); Adolfo S. MONTERO, Pflugerville, TX (US)

(73) Assignee: Dell Products L.P., Round Rock, TX (US)

(21) Appl. No.: 18/165,550

(22) Filed: Feb. 7, 2023

(51) Int. Cl. G06F 21/57

(52) U.S. Cl. CPC G06F 21/572; G06F 21/575; G06F 2221/034

(57) ABSTRACT

A method may include a management controller verifying integrity of firmware of the management controller using a public key and verifying integrity of a driver integrity table using the public key, wherein the driver integrity table sets forth a plurality of entries, each entry comprising identifying information for an executable module of the BIOS and a hash of executable code of such executable module signed by a private key, wherein the driver integrity table is signed by the private key and wherein the private key is associated with the public key. The method may further include performing, by the management controller, power sequencing of the information handling system to begin execution of the BIOS if integrity of the firmware and integrity of the driver integrity table are verified.

### TECHNICAL FIELD

The present disclosure relates in general to information handling systems, and more specifically to using a management controller to securely monitor and enforce integrity of basic input/output system (BIOS) modules during a boot process of an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may employ a BIOS. Generally speaking, a BIOS comprises executable code stored on computer-readable media (e.g., flash memory) that executes during a pre-boot phase of the information handling system to configure and initialize hardware of the information handling system in preparation for handing off control of such hardware to an operating system of the information handling system. Loading of BIOS firmware is critical, as it serves as a trusted foundation for the information handling system and operating system. Thus, system integrity and security starts with the BIOS, which serves as a fundamental protection layer for an information handling system.

Many known hardware-based root of trust and trust chaining mechanisms are available to properly boot to an authorized and verified operating system. BIOS root of trust and image integrity checks may be used to load Unified Extensible Firmware Interface (UEFI) images from the flash device to memory. Several security mechanisms may be available to enforce security protection while drivers (i.e., BIOS firmware) reside in a flash storage device. However, once the BIOS code is uncompressed from the flash storage and loaded into system memory, the BIOS code may be vulnerable to modification. Traditional approaches provide for no integrity enforcement after the BIOS image is uncompressed and loaded to the system memory. Accordingly, such code, once loaded into system memory, may be vulnerable during the entire boot process. For example, a buffer overflow attack or race condition attack can copy unauthorized code or can alter code in the system memory. Such attacks may lead to an unauthorized or tampered code being executed during the preboot process by BIOS protocols or BIOS events.

### SUMMARY

In accordance with the teachings of the present disclosure, the disadvantages and problems associated with security vulnerabilities in the loading and execution of BIOS drivers may be reduced or eliminated.

In accordance with embodiments of the present disclosure, an information handling system may include a processor and a basic input/output system (BIOS) comprising a program of instructions comprising boot firmware configured to be the first code executed by the processor when the information handling system is booted or powered on in order to initialize the information handling system for operation, and a management controller communicatively coupled to the processor and configured to provide out-of-band management facilities for management of the information handling system. The management controller may include firmware configured to perform functionality of the management controller, a driver integrity table setting forth a plurality of entries, each entry comprising identifying information for an executable module of the BIOS and a hash of executable code of such executable module signed by a private key, wherein the driver integrity table is signed by the private key, and a public key associated with the private key. The management controller may be further configured to verify integrity of a firmware of the management controller using the public key, verify integrity of the driver integrity table using the public key, and perform power sequencing of the information handling system to begin execution of the BIOS if the integrity of the firmware and the integrity of the driver integrity table are verified.

In accordance with these and other embodiments of the present disclosure, a method may be provided for an information handling system comprising a processor and a basic input/output system (BIOS) comprising a program of instructions comprising boot firmware configured to be the first code executed by the processor when the information handling system is booted or powered on in order to initialize the information handling system for operation. The method may include verifying, by a management controller communicatively coupled to the processor and configured to provide out-of-band management facilities for management of the information handling system, integrity of firmware of the management controller using a public key. The method may also include verifying, by the management controller, integrity of a driver integrity table using the public key, wherein the driver integrity table sets forth a plurality of entries, each entry comprising identifying information for an executable module of the BIOS and a hash of executable code of such executable module signed by a private key, wherein the driver integrity table is signed by the private key and wherein the private key is associated with the public key. The method may further include performing, by the management controller, power sequencing of the information handling system to begin execution of the BIOS if integrity of the firmware and integrity of the driver integrity table are verified.

In accordance with these and other embodiments of the present disclosure, an article of manufacture may include a computer readable medium and computer-executable instructions carried on the computer readable medium, the instructions readable by a processor, the instructions, when read and executed, for causing the processor to, in a management controller of an information handling system, wherein the management controller is configured to provide out-of-band management facilities for management of the information handling system: verify, by the management controller, integrity of firmware of the management controller using a public key; verify, by the management controller, integrity of a driver integrity table using the public key, wherein the driver integrity table sets forth a plurality of entries, each entry comprising identifying information for an executable module of a basic input/output system (BIOS) of the information handling system and a hash of executable code of such executable module signed by a private key, wherein the driver integrity table is signed by the private key and wherein the private key is associated with the public key; and perform, by the management controller, power sequencing of the information handling system to begin execution of the BIOS if integrity of the firmware and integrity of the driver integrity table are verified.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for using a management controller to securely monitor and enforce integrity of basic input/output system (BIOS) modules during a boot process of an information handling system, in accordance with certain embodiments of the present disclosure;

FIG. 2 illustrates a flow chart of an example method for generation and provisioning of a driver integrity table, in accordance with embodiments of the present disclosure; and

FIG. 3 illustrates a flow chart of an example method for using a management controller to securely monitor and enforce integrity of BIOS modules during a boot process of an information handling system.

### DETAILED DESCRIPTION

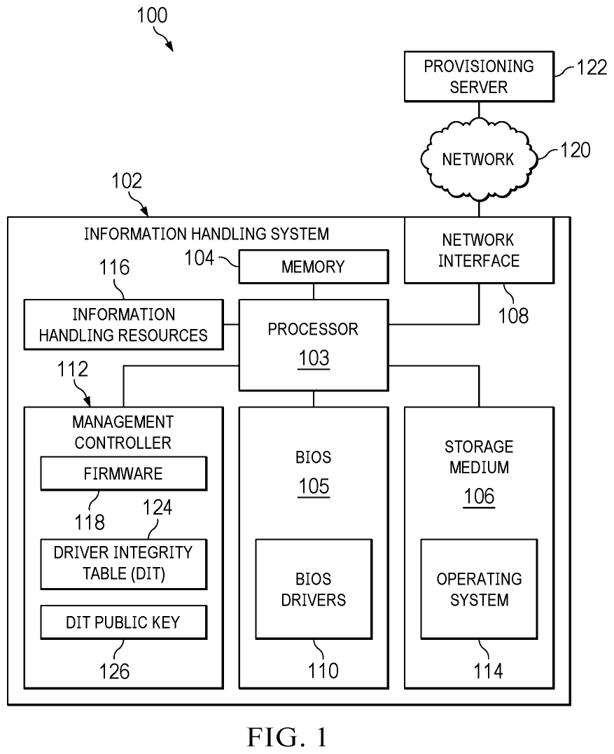

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more busses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RA), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, BIOSs, buses, memories, I/O devices and/or interfaces, storage resources, network interfaces, motherboards, and/or any other components and/or elements of an information handling system.

FIG. 1 illustrates a block diagram of an example system 100 for using a management controller 112 to securely monitor and enforce integrity of BIOS modules during a boot process of an information handling system 102, in accordance with certain embodiments of the present disclosure. As shown in FIG. 1, system 100 may include an information handling system 102 communicatively coupled to a provisioning server 122 via a network 120.

In some embodiments, information handling system 102 may comprise a server. In other embodiments, information handling system 102 may be a personal computer (e.g., a desktop computer, a laptop, notebook, tablet, handheld, smart phone, personal digital assistant, etc.). As depicted in FIG. 1, information handling system 102 may include a processor 103, a memory 104 communicatively coupled to processor 103, a BIOS 105 communicatively coupled to processor 103, a storage medium 106 communicatively coupled to processor 103, a network interface 108 communicatively coupled to processor 103, a management controller 112 communicatively coupled to processor 103, and one or more other information handling resources 116 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, storage medium 106, BIOS 105, and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

Storage medium 106 may be communicatively coupled to processor 103 and may include any system, device, or apparatus operable to store information processed by processor 103. Storage medium 106 may include, for example, network attached storage, one or more direct access storage devices (e.g., hard disk drives), and/or one or more sequential access storage devices (e.g., tape drives). As shown in FIG. 1, storage medium 106 may have stored thereon an operating system 114.

Operating system 114 may be any program of executable instructions, or aggregation of programs of executable instructions, configured to manage and/or control the allocation and usage of hardware resources such as memory, CPU time, disk space, and input and output devices, and provide an interface between such hardware resources and application programs hosted by operating system 114. Active portions of operating system 114 may be transferred to memory 104 for execution by processor 103.

BIOS 105 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a UEFI. In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., operating system 114 or other application programs) stored on compatible media (e.g., memory 104, storage medium 106) may be executed by processor 103 and given control of information handling system 102. As shown in FIG. 1, BIOS 105 may include a plurality of BIOS drivers 110. A BIOS driver 110 may comprise a program of instructions configured to, when read and executed by processor 103, provide an interface between BIOS 105 and hardware or firmware executing on an information handling resource 116.

Network interface 108 may comprise any suitable system, apparatus, or device operable to serve as an interface between information handling system 102 and one or more other information handling systems. Network interface 108 may enable information handling system 102 to communicate using any suitable transmission protocol and/or standard. In these and other embodiments, network interface 108 may comprise a network interface card, or “NIC.”

Management controller 112 may be configured to provide out-of-band management facilities for management of information handling system 102. Such management may be made by management controller 112 even if information handling system 102 is powered off or powered to a standby state. Management controller 112 may include a processor, memory, out-of-band network interface separate from and physically isolated from an in-band network interface of information handling system 102, and/or other embedded information handling resources. In certain embodiments, management controller 112 may include or may be an integral part of a baseboard management controller (BMC) or a remote access controller (e.g., a Dell Remote Access Controller or Integrated Dell Remote Access Controller). In other embodiments, management controller 112 may include or may be an integral part of a chassis management controller (CMC).

As shown in FIG. 1, management controller 112 may include firmware 118, a driver integrity table (DIT) 124, and a DIT public key 126.

Firmware 118 may include a program of executable instructions configured to be read and executed by management controller 112 in order to carry out the functionality of management controller 112, including functionality of management controller 112 described herein.

DIT 124 may comprise a table, list, map, and/or any other suitable data structure setting forth an entry for each of BIOS drivers 110 stored in BIOS 105, each entry setting forth an identity of the BIOS driver 110 and a hash for such entry computed by provisioning server 122, as described in greater detail below. As also described below, DIT 124 may be signed by a private key of provisioning server 122.

DIT public key 126 may be the public key corresponding to the private key used to sign DIT 124, and may be used by management controller 112 to verify the integrity of DIT 124, as described in greater detail below.

Generally speaking, information handling resources 116 may include any component system, device or apparatus of information handling system 102, including without limitation processors, buses, computer-readable media, input-output devices and/or interfaces, storage resources, network interfaces, motherboards, electro-mechanical devices (e.g., fans), displays, and/or power supplies.

In addition to processor 103, memory 104, BIOS 105, storage medium 106, network interface 108, management controller 112, and information handling resources 116, information handling system 102 may include one or more other information handling resources.

Network 120 may comprise a network and/or fabric configured to couple information handling system 102 and provisioning server 122 to each other and/or one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

Provisioning server 122 may comprise an information handling system, and may include any system, device, or apparatus configured to facilitate and manage end use provisioning of an operating system for network interface 108. For example, in some embodiments, provisioning server 122 may comprise a hardware security module (HSM) server that may serve as a security management platform for one or more components of information handling system 102.

In addition to information handling system 102, network 120, and provisioning server 122, system 100 may include any other suitable components, including without limitation other information handling systems.

In operation, provisioning server 122 may perform a build process to provision BIOS 105 and BIOS drivers 110, and following BIOS build, may execute a post-build tool that computes hashes for each BIOS driver 110 and creates DIT 124, including an entry for each BIOS driver 110 setting forth an identity for each BIOS driver 110 and the respective computed hash associated with each such BIOS driver 110. Accordingly, DIT 124 may be a static table built for information handling system 102 during the BIOS build process, and may never change for that build after being provisioned to management controller 112.

After completion of all hash entries in DIT 124, provisioning server 122 may sign DIT 124 with a private key associated with provisioning server 122. After signing, provisioning server 122 may communicate a DIT public key 126 for storage in management controller 112 and/or storage media accessible by management controller 112.

After deployment of information handling system 102 (e.g., to its intended end use), on each boot of information handling system 102, prior to BIOS execution, management controller 112 may use DIT public key 126 to verify the integrity of its own firmware 118 and DIT 124. If these verifications are successful, management controller 112 may enter into a security monitoring mode. Otherwise, management controller 112 may signal a security violation and may take a remedial action (e.g., powering down information handling system 102).

Further, even in scenarios in which BIOS drivers 110 are loaded into cache as RAM, integrity of BIOS drivers 110 may be checked via a secure interface between BIOS 105 and management controller 112. To illustrate, prior to executing a cache as RAM module, a pre-Extensible Firmware Interface Initialization (PEI) dispatcher may compute the hash of such a module and send it to management controller 112 for verification against a stored hash for such module within DIT 124. In response to any failed verification, management controller 112 may take a remedial action (e.g., powering down information handling system 102).

After memory 104 is initialized during a boot process, BIOS drivers 110 may be loaded into memory 104. Prior to executing a BIOS driver 110 in the Driver Execution Environment (DXE) and System Management Mode (SMM) phases of BIOS execution, a DXE dispatcher of BIOS 105 may compute a hash of such BIOS driver 110 and send it to management controller 112 for verification against a stored hash for such module within DIT 124. In response to any failed verification, management controller 112 may take a remedial action (e.g., powering down information handling system 102). Image verification/re-verification for a BIOS driver 110 may be triggered on any one of a number of several events, including without limitation a loading of a BIOS driver 110, a driver entry point function, connection of a controller, a driver binding protocol event, and/or other suitable event. In some embodiments, such triggering events may be defined by a security policy.

Management controller 112 may continue security monitoring of BIOS 105 during execution of BIOS 105 and/or operating system 114 until the next reset or boot of information handling system 102, and during such monitoring, log attempted security breaches for telemetry purposes and indicators of attack.

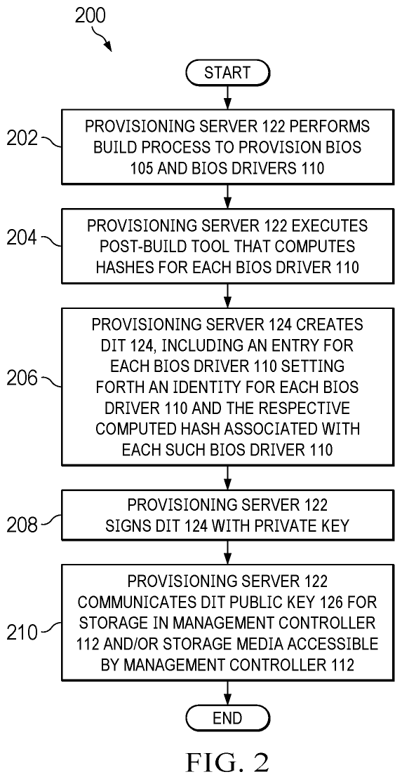

FIG. 2 illustrates a flow chart of an example method 200 for generation and provisioning of a driver integrity table, in accordance with embodiments of the present disclosure. According to certain embodiments, method 200 may begin at step 202. As noted above, teachings of the present disclosure may be implemented in a variety of configurations of information handling system 102 as shown in FIG. 1. As such, the preferred initialization point for method 200 and the order of the steps comprising method 200 may depend on the implementation chosen. In these and other embodiments, method 200 may be implemented as firmware, software, applications, functions, libraries, or other instructions.

At step 202, provisioning server 122 may perform a build process to provision BIOS 105 and BIOS drivers 110. At step 204, following the BIOS build, provisioning server 122 may execute a post-build tool that computes hashes for each BIOS driver 110. At step 206, provisioning server 122 may create DIT 124, including an entry for each BIOS driver 110 setting forth an identity for each BIOS driver 110 and the respective computed hash associated with each such BIOS driver 110. At step 208, after completion of all hash entries in DIT 124, provisioning server 122 may sign DIT 124 with a private key associated with provisioning server 122. At step 210, after signing, provisioning server 122 may communicate a DIT public key 126 for storage in management controller 112 and/or storage media accessible by management controller 112.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using information handling system 102, components thereof, or any other system such as those shown in FIG. 1 operable to implement method 200. In certain embodiments, method 200 may be implemented partially or fully in software and/or firmware embodied in computer-readable media.

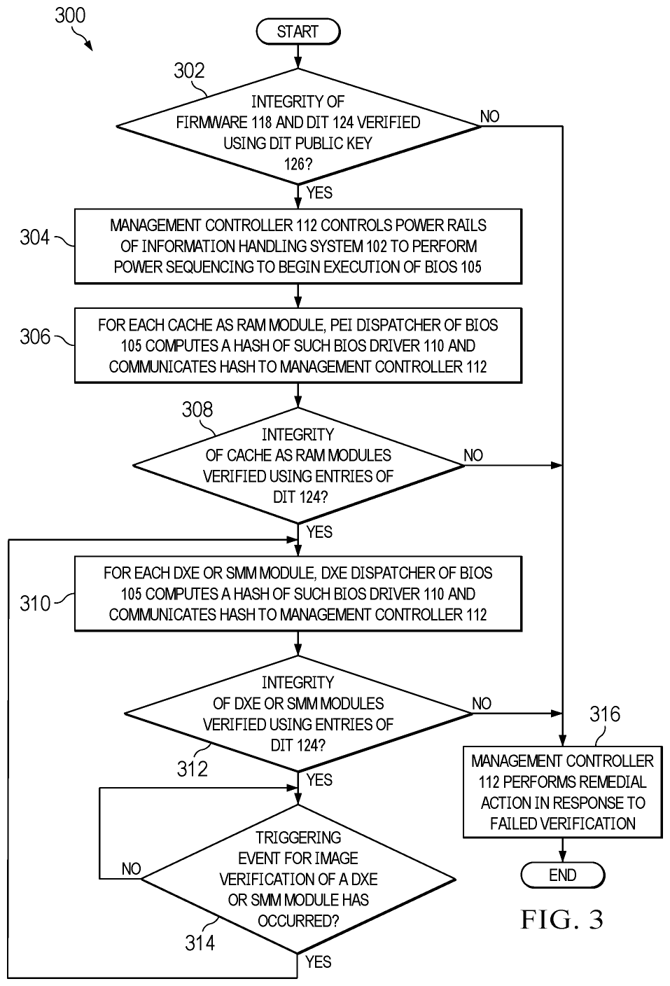

FIG. 3 illustrates a flow chart of an example method 300 for using management controller 122 to securely monitor and enforce integrity of BIOS modules during a boot process of information handling system 102. According to certain embodiments, method 300 may begin at step 302. As noted above, teachings of the present disclosure may be implemented in a variety of configurations of information handling system 102 as shown in FIG. 1. As such, the preferred initialization point for method 300 and the order of the steps comprising method 300 may depend on the implementation chosen. In these and other embodiments, method 300 may be implemented as firmware, software, applications, functions, libraries, or other instructions.

At step 302, upon boot of information handling system 102 and prior to execution of BIOS 105, management controller 112 may use DIT public key 126 to verify the integrity of firmware 118 and DIT 124. If these verifications are successful, method 300 may proceed to step 304 where management controller 112 may enter a security monitoring mode. On the other hand, if any of these verifications fail, method 300 may proceed to step 316.

At step 304, management controller 112 may control power rails of information handling system 102 to perform power sequencing to begin execution of BIOS 105.

At step 306, prior to execution of each BIOS driver 105 executing as a cache as RAM module, a PEI dispatcher of BIOS 105 may compute a hash of such BIOS driver 110 and communicate the hash to management controller 112. At step 308, for each such hash, management controller 112 may compare the hash against the corresponding entry in DIT 124 for such BIOS driver 110 to verify integrity of such BIOS driver 110. If integrity of all such BIOS drivers is verified, method 300 may proceed to step 310. Otherwise, method 300 may proceed to step 316.

At step 310, following initialization of memory 104 and loading of BIOS drivers 110 into memory 104, for each BIOS driver 110 which is a DXE or SMM module, a DXE dispatcher of BIOS 105 may compute a hash of such BIOS driver 110 and communicate the hash to management controller 112. At step 312, for each such hash, management controller 112 may compare the hash against the corresponding entry in DIT 124 for such BIOS driver 110 to verify integrity of such BIOS driver 110. If integrity of all such BIOS drivers is verified, method 300 may proceed to step 314. Otherwise, method 300 may proceed to step 316.

At step 314, management controller 112 may determine if a triggering event for image verification of a DXE or SMM module has occurred. If such triggering event has occurred, method 300 may proceed again to step 310. Otherwise, method 300 may remain at step 314 until such a triggering event occurs.

At step 316, management controller 112 may perform a remedial action in response to a failed verification. In some embodiments, such remedial action may include powering down information handling system 102 and/or issuing/recording an alert indicative of the failed verification. After completion of step 316, method 300 may end.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using information handling system 102, components thereof, or any other system such as those shown in FIG. 1 operable to implement method 300. In certain embodiments, method 300 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor; and
a basic input/output system (BIOS) comprising a program of instructions comprising boot firmware configured to be the first code executed by the processor when the information handling system is booted or powered on in order to initialize the information handling system for operation; and
a management controller communicatively coupled to the processor and configured to provide out-of-band management facilities for management of the information handling system, the management controller comprising:
firmware configured to perform functionality of the management controller;
a driver integrity table setting forth a plurality of entries, each entry comprising identifying information for an executable module of the BIOS and a hash of executable code of such executable module signed by a private key, wherein the driver integrity table is signed by the private key; and
a public key associated with the private key;
wherein the management controller is further configured to:
verify integrity of a firmware of the management controller using the public key;
verify integrity of the driver integrity table using the public key; and
perform power sequencing of the information handling system to begin execution of the BIOS if the integrity of the firmware and the integrity of the driver integrity table are verified.

2. The information handling system of claim 1, wherein the management controller is configured to perform a remedial action if verification of either of the integrity of the firmware or the integrity of the driver integrity table fails.

3. The information handling system of claim 2, wherein the remedial action comprises powering down the information handling system.

4. The information handling system of claim 1, wherein the management controller is further configured to, prior to execution of each executable module:
receive from the BIOS a calculated hash for such executable module;
using the public key and the driver integrity table, compare the calculated hash to a stored hash for such executable module stored in the driver integrity table;
permit execution of such executable module if the calculated hash for such executable module matches the stored hash for such executable module; and
perform a remedial action if the calculated hash for such executable module fails to match the stored hash for such executable module.

5. The information handling system of claim 4, wherein the remedial action comprises powering down the information handling system.

6. The information handling system of claim 4, wherein the calculated hash is calculated by a dispatcher of the BIOS.

7. The information handling system of claim 1, wherein the driver integrity table and the public key are written to the management controller by a provisioning server after build of the BIOS.

8. A method comprising, in an information handling system comprising a processor and a basic input/output system (BIOS) comprising a program of instructions comprising boot firmware configured to be the first code executed by the processor when the information handling system is booted or powered on in order to initialize the information handling system for operation:
verifying, by a management controller communicatively coupled to the processor and configured to provide out-of-band management facilities for management of the information handling system, integrity of firmware of the management controller using a public key;
verifying, by the management controller, integrity of a driver integrity table using the public key, wherein the driver integrity table sets forth a plurality of entries, each entry comprising identifying information for an executable module of the BIOS and a hash of executable code of such executable module signed by a private key, wherein the driver integrity table is signed by the private key and wherein the private key is associated with the public key; and
performing, by the management controller, power sequencing of the information handling system to begin execution of the BIOS if integrity of the firmware and integrity of the driver integrity table are verified.

9. The method of claim 8, further comprising performing, by the management controller, a remedial action if verification of either of the integrity of the firmware or the integrity of the driver integrity table fails.

10. The method of claim 9, wherein the remedial action comprises powering down the information handling system.

11. The method of claim 8, further comprising, prior to execution of each executable module:
receiving, by the management controller, a calculated hash from the BIOS for such executable module;
using, by the management controller, the public key and the driver integrity table to compare the calculated hash to a stored hash for such executable module stored in the driver integrity table;
permitting, by the management controller, execution of such executable module if the calculated hash for such executable module matches the stored hash for such executable module; and
performing, by the management controller, a remedial action if the calculated hash for such executable module fails to match the stored hash for such executable module.

12. The method of claim 11, wherein the remedial action comprises powering down the information handling system.

13. The method of claim 11, wherein the calculated hash is calculated by a dispatcher of the BIOS.

14. The method of claim 8, wherein the driver integrity table and the public key are written to the management controller by a provisioning server after build of the BIOS.

15. An article of manufacture comprising:
a computer readable medium; and
computer-executable instructions carried on the computer readable medium, the instructions readable by a processor, the instructions, when read and executed, for causing the processor to, in a management controller of an information handling system, wherein the management controller is configured to provide out-of-band management facilities for management of the information handling system:
verify, by the management controller, integrity of firmware of the management controller using a public key;
verify, by the management controller, integrity of a driver integrity table using the public key, wherein the driver integrity table sets forth a plurality of entries, each entry comprising identifying information for an executable module of a basic input/output system (BIOS) of the information handling system and a hash of executable code of such executable module signed by a private key, wherein the driver integrity table is signed by the private key and wherein the private key is associated with the public key; and
perform, by the management controller, power sequencing of the information handling system to begin execution of the BIOS if integrity of the firmware and integrity of the driver integrity table are verified.

16. The article of claim 15, further comprising performing, by the management controller, a remedial action if verification of either of the integrity of the firmware or the integrity of the driver integrity table fails.

17. The article of claim 16, wherein the remedial action comprises powering down the information handling system.

18. The article of claim 15, further comprising, prior to execution of each executable module:
receiving, by the management controller, a calculated hash from the BIOS for such executable module;
using, by the management controller, the public key and the driver integrity table to compare the calculated hash to a stored hash for such executable module stored in the driver integrity table;
permitting, by the management controller, execution of such executable module if the calculated hash for such executable module matches the stored hash for such executable module; and
performing, by the management controller, a remedial action if the calculated hash for such executable module fails to match the stored hash for such executable module.

19. The article of claim 18, wherein the remedial action comprises powering down the information handling system.

20. The article of claim 18, wherein the calculated hash is calculated by a dispatcher of the BIOS.

21. The article of claim 15, wherein the driver integrity table and the public key are written to the management controller by a provisioning server after build of the BIOS.
